(19) United States
(12) Patent Application Publication
(10) Pub. No.: US 2025/0389496 A1
(43) Pub. Date: Dec. 25, 2025

(54) COOLING DEVICE AND METHOD FOR MANUFACTURING COOLING DEVICE

(71) Applicant: TOYOTA JIDOSHA KABUSHIKI KAISHA, Toyota-shi (JP)

(72) Inventor: Osamu YAMASHITA, Toyota-shi (JP)

(73) Assignee: TOYOTA JIDOSHA KABUSHIKI KAISHA, Toyota-shi (JP)

(21) Appl. No.: 19/019,681

(22) Filed: Jan. 14, 2025

(30) Foreign Application Priority Data
Jun. 25, 2024 (JP) 2024-101679

(51) Int. Cl. F28F 9/00

(52) U.S. Cl. CPC F28F 9/001

(57) ABSTRACT

The cooling device according to the present disclosure includes an exterior portion having a flat cooling surface on the front and back sides thereof, and a deformation suppressing portion housed in the interior of the exterior portion and suppressing deformation of the exterior portion. The exterior portion is a single metal member having a bent structure at the boundary between the front side portion and the back side portion, and accommodates the deformation suppressing portion so as to sandwich the bent structure as an axis.

### CROSS-REFERENCE TO RELATED APPLICATION

This application claims priority to Japanese Patent Application No. 2024-101679 filed on Jun. 25, 2024. The disclosure of the above-identified application, including the specification, drawings, and claims, is incorporated by reference herein in its entirety.

### BACKGROUND

### 1. Technical Field

The present disclosure relates to a cooling device and a method for manufacturing the cooling device.

### 2. Description of Related Art

Japanese Unexamined Patent Application Publication No. 2023-011369 (JP 2023-011369 A) describes a cooling device and a method for manufacturing the cooling device. The method for manufacturing the cooling device described in JP 2023-011369 A includes a step of forming a flow path of a coolant and a substrate, a bending step of bending the substrate, and a welding step of performing laser welding.

### SUMMARY

The cooling device described in JP 2023-011369 A is a cooling device having a cooling surface on only one side, but a cooling device having cooling surfaces on both sides is also known. When the cooling surfaces are provided on both sides, there is a problem that the number of members of the exterior portion of the cooling device increases, and accordingly, leakage of the coolant is likely to occur. JP 2023-011369 A does not disclose a technology capable of solving such a problem.

The present disclosure has been made to solve such a problem, and provides a cooling device capable of suppressing leakage of a coolant and a method for manufacturing the cooling device.

A cooling device according to the present disclosure includes:
an exterior portion including flat cooling surfaces on front and back sides; and
a deformation suppressing portion that is housed inside the exterior portion and suppresses deformation of the exterior portion.

The exterior portion is a single metal member including a bent structure at a boundary between a front side portion and a back side portion, and houses the deformation suppressing portion while sandwiching the deformation suppressing portion with the bent structure as an axis.

In such a configuration, part of the edges of the exterior portion of the cooling device serves as the bent structure of the metal member, and a portion that may cause a gap that is a factor of the leakage of the coolant is reduced. As a result, the cooling device according to the present disclosure can suppress the leakage of the coolant.

In the cooling device according to the present disclosure,
the exterior portion and the deformation suppressing portion may be a single metal member including a second bent structure at a boundary between the exterior portion and the deformation suppressing portion.

In such a configuration, the portion that may cause a gap that is a factor of the leakage of the coolant is reduced. Therefore, the leakage of the coolant can be further suppressed.

In the cooling device according to the present disclosure,
edges of the exterior portion may be welded except for a side where the boundary between the front side portion and the back side portion is located.

In such a configuration, the length of a welding line is reduced. Therefore, the manufacturing cost can be reduced.

In the cooling device according to the present disclosure,
the bent structure located at the boundary between the front side portion and the back side portion may include two cut structures on an inner side.

The two cut structures may be disposed at a distance corresponding to a thickness of the deformation suppressing portion.

In such a configuration, the occurrence of the gap in the vicinity of the end of the deformation suppressing portion can be suppressed. As a result, the leakage of the coolant can be further suppressed.

In a method for manufacturing a cooling device according to the present disclosure,
the cooling device includes an exterior portion including flat cooling surfaces on front and back sides, and a deformation suppressing portion that is housed inside the exterior portion and suppresses deformation of the exterior portion.

The method for manufacturing the cooling device according to the present disclosure includes a press-forming step and a bending step.

The press-forming step is a step of press-forming the exterior portion on a metal plate.

The bending step is a step of bending the metal plate at a boundary between a front side portion and a back side portion of the exterior portion to house the deformation suppressing portion in the exterior portion.

According to the present disclosure, it is possible to provide the cooling device capable of suppressing the leakage of the coolant and the method for manufacturing the cooling device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view showing a configuration of a cooling device according to a first embodiment;

FIG. 2A is a diagram illustrating a configuration of a cooling device according to a first embodiment;

FIG. 2B is a diagram illustrating a configuration of a cooling device according to a first embodiment;

FIG. 2C is a diagram illustrating a configuration of a cooling device according to a first embodiment;

FIG. 3 is a cross-sectional view showing a configuration of a cooling device according to a first embodiment;

FIG. 4 is a flowchart illustrating a configuration of a method for manufacturing a cooling device according to the first embodiment;

FIG. 5A is a block diagram illustrating a configuration of a method for manufacturing a cooling device according to a first embodiment; and

FIG. 5B is a block diagram illustrating a configuration of a method for manufacturing a cooling device according to a first embodiment.

### DETAILED DESCRIPTION OF EMBODIMENTS

### First Embodiment

### Cooling Device Configuration

Hereinafter, a first embodiment according to the present disclosure will be described in detail with reference to the drawings. First, the configuration of the cooling device according to the present embodiment will be described in detail.

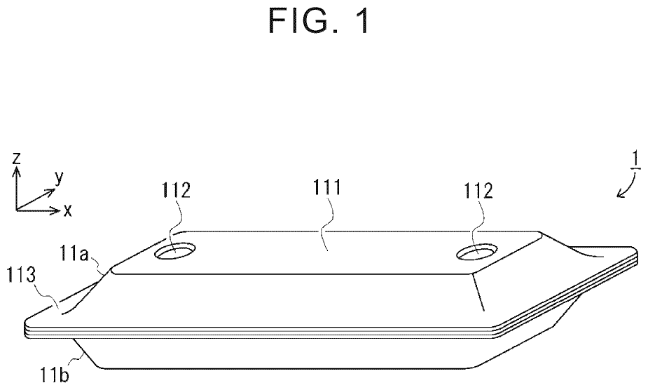

FIG. 1 is a perspective view illustrating a configuration of a cooling device according to a first embodiment.

It should be understood that the right-hand xyz orthogonal coordinates illustrated in FIG. 1 and the other drawings are for convenience of describing the positional relation of the constituent elements, and are the same among the drawings.
In addition, the scale of FIG. 1 and other drawings may be different from each other.

The cooling device 1 is a device used for cooling an object to be cooled. More specifically, the cooling device 1 cools the cooling surface of the apparatus exterior by the cooling liquid flowing inside the apparatus. Then, the cooled cooling surface comes into contact with the object to be cooled, and as a result, the object to be cooled is cooled. The object to be cooled may be any object having a shape capable of contacting the cooling surface of the cooling device 1, for example, the object to be cooled is a power storage module.

As shown in FIG. 1, the cooling device 1 according to the present embodiment is a plate-shaped device having a substantially rectangular upper surface when viewed from the z-axis direction. The cooling device 1 has cooling surfaces on the front and back sides as viewed from the positive direction and the negative direction of the z-axis.

In the following description, for clarity of explanation, the surface of the cooling device 1 as viewed from the positive direction of the z-axis is referred to as a surface, and the surface of the cooling device 1 as viewed from the negative direction of the z-axis may be referred to as a back surface. It should be understood that these designations are merely for convenience and are not intended to limit the arrangement direction, other configurations, and the like when the cooling device 1 is used. The same applies to the front side portion 11a and the back side portion 11b, which will be described later.

For example, the cooling device 1 may be disposed in a gap between the power storage modules in the power storage device including the plurality of power storage modules. In such a case, the cooling device 1 can cool the plurality of power storage modules at the same time by using the cooling surfaces provided on the front surface and the back surface.

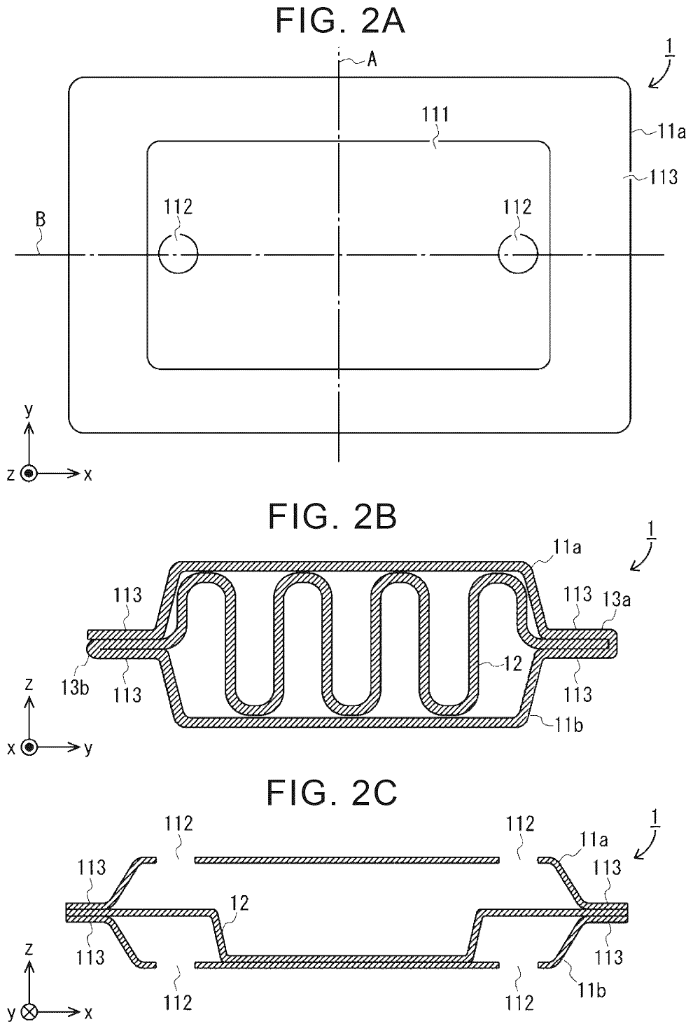

FIGS. 2A to 2C are diagrams illustrating a configuration of a cooling device according to a first embodiment.

More specifically, FIG. 2A is a view of the cooling device 1 viewed from the positive z-axis. Further, FIG. 2B is a diagram of the cooling device 1 when the cooling device 1 is cut at the cut surface A described in FIG. 2A. Further, FIG. 2C is a diagram of the cooling device 1 when the cooling device 1 is cut at the cut surface B described in FIG. 2A.

As shown in FIGS. 2B and 2C, the cooling device 1 includes an exterior portion 11 having a flat cooling surface 111 on the front and back sides, and a deformation suppressing portion 12 accommodated in the interior of the exterior portion 11 and suppressing deformation of the exterior portion 11.

The exterior portion 11 is a box-shaped metal member having a flat cooled surface on the front and back sides and having an inner space, and is composed of a front side portion 11a and a back side portion 11b which are plate-shaped portions each having a concave structure. The inner space of the exterior portion 11 is formed by combining the recessed features of the front side portion 11a and the back side portion 11b.

The deformation suppressing portion 12 is accommodated in the internal space of the exterior portion 11. In other words, the exterior portion 11 houses the deformation suppressing portion 12.

The exterior portion 11 is supported from the inside by the deformation suppressing portion 12. Therefore, deformation of the exterior portion 11 is suppressed even when excessive force is applied from the outside.

The exterior portion 11 is one metal member having a bent structure 13a at the boundary between the front side portion 11a and the back side portion 11b, and accommodates the deformation suppressing portion 12 so as to sandwich the bent structure 13a as a shaft.

In other words, the front side portion 11a and the back side portion 11b according to the present embodiment are constituted by one metal plate bent at the boundary between the front side portion 11a and the back side portion 11b. The front side portion 11a and the back side portion 11b provided on one metal plate are connected by a bent structure 13a, and are disposed so as to face each other via the deformation suppressing portion 12. That is, the front side portion 11a and the back side portion 11b are connected to each other on one side of the exterior portion 11.

As described above, the exterior portion 11 is formed of a metal plate which is connected at one side thereof. Here, since there cannot be a gap formed between the front side portion 11a and the back side portion 11b, which causes the leakage of the cooling liquid, on the one side, the possibility that the leakage of the cooling liquid occurs is extremely low. That is, the cooling device 1 according to the present embodiment can suppress the leakage of the cooling liquid by the above-described configuration.

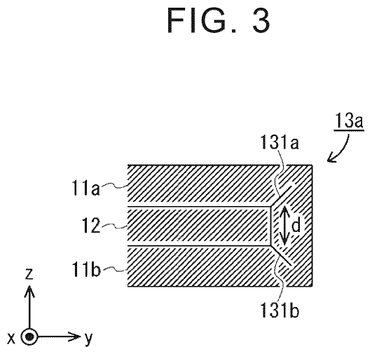

FIG. 3 is a cross-sectional view illustrating a configuration of a bent structure according to the first embodiment. More specifically, FIG. 3 is an enlarged cross-sectional view of the bent structure 13a shown in FIG. 2C.

As shown in FIG. 3, the bent structure 13a according to the present embodiment may have two cut structures 131a and 131b on the inner side. The two cut structures 131a and 131b may be arranged at a distance d corresponding to the thickness of the deformation suppressing portion 12.
According to such a configuration, it is possible to suppress the occurrence of a gap between the bent structure 13a and the end portion of the deformation suppressing portion 12. As a result, the cooling device 1 according to the present embodiment can further suppress the leakage of the cooling liquid.

In addition, the internal space of the exterior portion 11 functions as a flow path for the cooling liquid. The cooling liquid flowing through the internal space cools the cooling surface 111 provided in the exterior portion 11, and the cooling surface 111 cooled by the cooling liquid cools the object to be cooled which is in contact with the cooling surface 111. That is, the cooling liquid flowing through the internal space indirectly cools the object to be cooled via the cooling surface 111.

As the cooling liquid, for example, water, an antifreeze, or the like can be used, but any liquid may be used as long as it is a liquid that is generally used as a cooling liquid.

The front side portion 11a and the back side portion 11b each include a cooling surface 111, a coolant hole portion 112, and an edge portion 113.

Note that, as described above, the designation of the front side portion 11a and the back side portion 11b is merely a convenience designation for clarity of explanation, and is not intended to limit the arrangement direction when the cooling device 1 is used, the configuration, and the like in any way.

The cooling surface 111 is a flat surface corresponding to the bottom surface of the concave structure of the front side portion 11a and the back side portion 11b, and is supported by the deformation suppressing portion 12 from the inside of the cooling device 1.

The cooling surface 111 is cooled by the cooling liquid flowing through the internal space. The cooled cooling surface 111 comes into contact with the object to be cooled on the outside of the cooling device 1, and cools the object to be cooled.

The cooling surface 111 according to the present embodiment is connected to the edge portion 113 via an inclined connection surface. According to such a configuration, it is possible to suppress occurrence of a molding defect during molding of the cooling surface 111. However, the configuration of the cooling surface 111 according to the present disclosure is not limited to this, and may be connected to the edge portion 113 via a surface perpendicular to the cooling surface 111, for example.

The coolant hole portion 112 is a hole provided in the cooling surface 111, and functions as an injection hole or a discharge hole of the cooling liquid. Two coolant hole portions 112 are provided for one cooling surface 111, one of which functions as a cooling liquid injection hole, and the other of which functions as a cooling liquid discharge hole.

However, in the cooling device 1 according to the present disclosure, a position where the coolant hole portion 112 can be provided is not limited to the cooling surface 111.

The coolant hole portion 112 may be provided in any position as long as the cooling liquid can be injected or discharged into the cooling device 1, and for example, the coolant hole portion 112 may be provided on a surface connecting the cooling surface 111 and the edge portion 113.

The cooling liquid flows into the internal space of the cooling device 1 from the coolant hole portion 112 functioning as an injection hole, and cools the cooling surface 111 from the inside. The cooling liquid having cooled the cooling surface 111 flows out from the coolant hole portion 112 functioning as a discharge hole.

In use of the cooling device 1, a cooling liquid injection member or a cooling liquid discharge member (not shown) is attached to the coolant hole portion 112. For example, each of the injection member and the discharge member includes a pipe that serves as a flow path for the cooling liquid, and a fixture that fixes the pipe to the coolant hole portion 112.

The edge portion 113 is an edge-like portion located at the outer edge of the concave structure of the front side portion 11a and the back side portion 11b. The edge portion 113 on the front side portion 11a and the edge portion 113 on the back side portion 11b are welded via the deformation suppressing portion 12.

Here, the edge portion 113 may be welded except for a side where the boundary between the front side portion 11a and the back side portion 11b is located. According to such a configuration, since the welding step at the time of manufacturing is shortened, the cooling device according to the present embodiment can suppress the manufacturing cost.

As described above, there may be no gap formed between the front side portion 11a and the back side portion 11b, which causes leakage of the coolant, on the side where the boundary between the front side portion 11a and the back side portion 11b is located. Therefore, the cooling device 1 can sufficiently suppress the leakage of the cooling liquid without performing the welding on the side where the boundary between the front side portion 11a and the back side portion 11b is located.

The deformation suppressing portion 12 is housed inside the exterior portion 11, and suppresses deformation of the exterior portion 11. As shown in FIG. 2B, the deformation suppressing portion 12 according to the present embodiment is a metal member having a corrugated cross section, and the linear concavo-convex structure extends parallel to the x-axis direction.

The deformation suppressing portion 12 is in contact with the inner portion of the exterior portion 11 in the vicinity of each apex of the uneven structure, and supports the cooling surface 111 from the inner side of the exterior portion 11. With such a configuration, the deformation suppressing portion 12 suppresses deformation of the exterior portion 11.

In addition, the deformation suppressing portion 12 divides the internal space of the exterior portion 11 in a line shape parallel to the x-axis, and also functions as a flow path for facilitating the flow of the cooling liquid flowing in the internal space from the injection hole to the discharge hole.

Therefore, the uneven structure of the deformation suppressing portion 12 is preferably present only in a portion corresponding to the gap between the two coolant hole portions 112 of one cooling surface 111. According to such a configuration, all the internal spaces divided by the deformation suppressing portion 12 are filled with the cooling liquid injected from the coolant hole portion 112. As a result, the cooling device 1 can cool the object to be cooled more efficiently.

As described above, the deformation suppressing portion 12 according to the present embodiment is a metal member having a corrugated cross section, and the linear uneven structure extends parallel to the x-axis direction, but the shape of the deformation suppressing portion 12 according to the present disclosure is not limited thereto.

For example, the deformation suppressing portion 12 may have a zigzag cross-section or a pulse waveform cross-section.
That is, the deformation suppressing portion 12 may have any shape as long as it supports the exterior portion 11 from the inside and can control the flow of the cooling liquid in one direction.

Here, the exterior portion 11 and the deformation suppressing portion 12 according to the present embodiment are one metal member having a second bent structure 13b at the boundary between the exterior portion 11 and the deformation suppressing portion 12. In other words, the exterior portion 11 and the deformation suppressing portion 12 according to the present embodiment are constituted by one metal plate bent so as to have a cross section of a spiral shape.

According to such a configuration, the cooling device according to the present disclosure can be manufactured from one metal member, and as a result, the manufacturing cost can be suppressed.

However, the exterior portion 11 and the deformation suppressing portion 12 according to the present disclosure do not necessarily have to be formed of one metal member, and the deformation suppressing portion 12 may be formed of a metal member different from the exterior portion 11. That is, the cooling device according to the present disclosure may include an exterior portion made of a first metal member having a bent structure at a boundary between the front side portion and the back side portion, and a deformation suppressing portion made of a second metal member.

As described above, the cooling device 1 according to the present embodiment includes the exterior portion 11 made of one metal member having a bent structure 13a, and the exterior portion 11 accommodates the deformation suppressing portion 12 so as to sandwich the bent structure 13a as a shaft.

According to such a configuration, a portion of the edge portion having an exterior portion of the cooling device becomes a bent structure of the metal member, a portion that may cause a gap that is a factor of the leakage of the coolant is reduced. As a result, the cooling device according to the present disclosure can suppress leakage of the coolant.

Further, in the cooling device 1 according to the present embodiment, the exterior portion 11 and the deformation suppressing portion 12 may be a single metal member having a second bent structure 13b at the boundary between the exterior portion 11 and the deformation suppressing portion 12. According to such a configuration, a portion where there is a possibility of generating a gap that causes leakage of water is reduced, so that leakage of the coolant can be further suppressed.

Further, in the cooling device 1 according to the present embodiment, the edge portion 113 of the exterior portion 11 may be welded except for the side where the boundary between the front side portion 11a and the back side portion 11b is located. According to such a configuration, since the length of the welding line is reduced, the manufacturing cost can be suppressed.

Further, in the cooling device 1 according to the present embodiment, the bent structure 13a located at the boundary between the front side portion 11a and the back side portion 11b may have two cut structures 131a and 131b on the inner side. The two cut structures 131a and 131b may be arranged at a distance d corresponding to the thickness of the deformation suppressing portion 12.

According to such a configuration, the occurrence of the gap in the vicinity of the end portion of the deformation suppressing portion can be suppressed, and as a result, the leakage of the coolant can be further suppressed.

### Cooling Device and Method of Manufacturing the Same

Next, a method of manufacturing the cooling device according to the first embodiment will be described in detail.

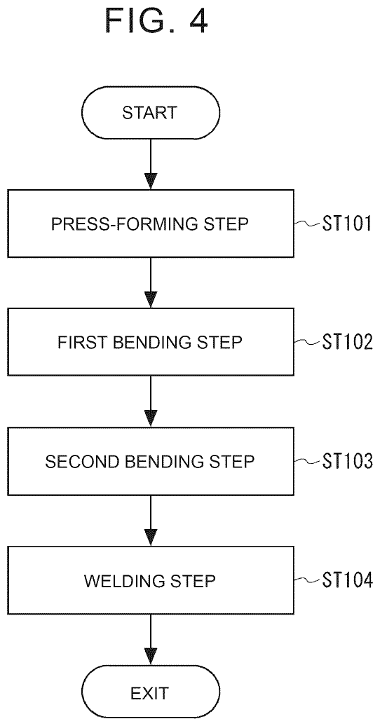

FIG. 4 is a flowchart illustrating a method of manufacturing the cooling device according to the first embodiment.

As shown in FIG. 4, the manufacturing process of the cooling device according to the present embodiment includes a press-forming step ST101, a first bending step ST102, a second bending step ST103, and a welding step ST104.

In the case where the exterior portion 11 and the deformation suppressing portion 12 are formed of different metal members, the first bending step may be omitted. The welding step ST104 can also be replaced by other processes for bonding the metal. Therefore, it can be said that the method for manufacturing the cooling device according to the present embodiment only needs to include a press-forming step and a second bending step.

In the manufacturing process of the cooling device according to the present embodiment, the press-forming step ST101 is first performed. In the press-forming step ST101, the front side portion 11a and the back side portion 11b of the exterior portion 11 and the deformation suppressing portion 12 are press-molded with respect to the metal plate M.

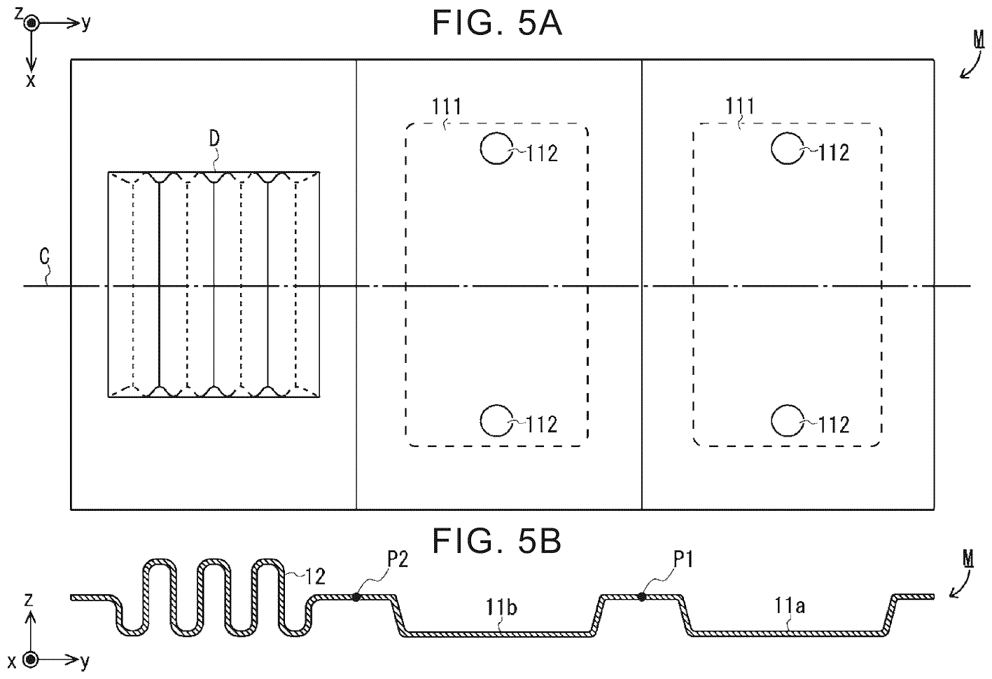

FIGS. 5A and 5B are diagrams illustrating a method of manufacturing a cooling device according to a first embodiment of the present disclosure.

More specifically, FIG. 5A is a view of the metal plate M after the press-forming step ST101 is performed when viewed from the positive z-axis.
Further, FIG. 5B is a view when the metal plate M after the press-forming step ST101 is performed is cut at the cut surface C described in FIG. 5A.

Note that a broken line indicating the cooling surface 111 of the front side portion 11a and the back side portion 11b described in FIG. 5A means that the cooling surface 111 of the back side portion 11b is located on the negative side of the z-axis with respect to the drawing surface.

Further, reference numeral D attached to the inside of the deformation suppressing portion 12 described in FIG. 5A indicates an area where the above-described uneven structure exists in the deformation suppressing portion 12. A solid line in the region D illustrates an uneven structure located on the positive side of the z-axis with respect to the plane of the drawing. A broken line in the region D illustrates a concavo-convex structure located on the positive-negative side of the z-axis relative to the plane of the drawing.

As shown in FIGS. 5A and 5B, the deformation suppressing portion 12, the back side portion 11b, and the front side portion 11a of the metal plate M after the press-forming step ST101 is performed are molded in the order described.

Here, in the metal plate M, a boundary P1 between the front side portion 11a and the back side portion 11b and a boundary P2 between the back side portion 11b and the deformation suppressing portion 12 are set.

In the manufacturing process of the cooling device according to the present embodiment, the first bending step ST102 is executed after the press-forming step ST101 is executed.

In the first bending step ST102, the metal plate M is bent at the boundary between the deformation suppressing portion 12 and the exterior portion 11. More particularly, in the bending step ST102 according to the present embodiment, first, the boundary P2 as a shaft, the deformation suppressing portion 12 is bent metal plate M so as to rotate clockwise, the back portion accommodating the deformation suppressing portion 12 in the concave structure of 11b.

In the manufacturing process of the cooling device according to the present embodiment, the second bending step ST103 is executed after the first bending step ST102 is executed.

In the second bending step ST103, the deformation suppressing portion 12 is accommodated in the exterior portion 11 by bending the metal plate at the boundary P1 between the front side portion 11a and the back side portion 11b of the exterior portion 11. More specifically, the deformation suppressing portion 12 is accommodated in the exterior portion 11 such that the metal plate M is bent so that the front side portion 11a rotates in a half-clockwise direction with the boundary P1 as an axis, and is sandwiched between the front side portion 11a and the back side portion 11b.

As described above, the bent structure 13a according to the present embodiment may have two cut structures 131a and 131b on the inner side.

If the bent structure 13a has cut structures 131a and 131b, the cut structures 131a and 131b are molded prior to performing the second bending step ST103. The cut structures 131a and 131b may be molded together with the exterior portion 11 and the deformation suppressing portion 12 in the press-forming step ST101, for example, or may be molded by cutting the metal plate M after performing the press-forming step ST101.

In the manufacturing process of the cooling device according to the present embodiment, finally, the welding step ST104 is performed. In the welding step ST104, the edge portion 113 on the front side portion 11a and the edge portion 113 on the back side portion 11b are welded to complete the cooling device 1 according to the present embodiment.

As described above, in the welding step ST104 according to the present embodiment, the edge portion 113 welds the edge portion 113 of the exterior portion 11 except for the side where the boundary between the front side portion 11a and the back side portion 11b is located.

As described above, in the manufacturing process of the cooling device according to the present embodiment, the front side portion 11a and the back side portion 11b of the exterior portion 11 are press-molded onto one metal plate M. The deformation suppressing portion 12 is accommodated in the exterior portion 11 by bending the metal plate at the boundary between the front side portion 11a and the back side portion 11b. With such a configuration, the cooling device 1 according to the present embodiment can be manufactured.

Further, in the manufacturing process of the cooling device according to the present embodiment, the front side portion 11a and the back side portion 11b of the exterior portion 11 and the deformation suppressing portion 12 are press-molded with respect to the metal plate M in the press-forming step. The method of manufacturing the cooling device according to the present embodiment includes a step of bending the metal plate M at the boundary between the deformation suppressing portion 12 and the exterior portion 11. According to such a configuration, in the method of manufacturing the cooling device according to the present embodiment, the cooling device 1 can be manufactured from one metal member, and as a result, the manufacturing cost can be suppressed.

Although the present disclosure has been described with reference to the above embodiments, it is to be understood that the disclosure is not limited only to the configuration of the above embodiments, but also includes various modifications, modifications, and combinations that may be made by a person skilled in the art within the scope of the claimed disclosure of the claims of the present application.

What is claimed is:

1. A cooling device comprising:
an exterior portion including flat cooling surfaces on front and back sides; and
a deformation suppressing portion that is housed inside the exterior portion and suppresses deformation of the exterior portion, wherein
the exterior portion is a single metal member including a bent structure at a boundary between a front side portion and a back side portion, and houses the deformation suppressing portion while sandwiching the deformation suppressing portion with the bent structure as an axis.

2. The cooling device according to claim 1, wherein the exterior portion and the deformation suppressing portion are a single metal member including a second bent structure at a boundary between the exterior portion and the deformation suppressing portion.

3. The cooling device according to claim 1, wherein edges of the exterior portion are welded except for a side where the boundary between the front side portion and the back side portion is located.

4. The cooling device according to claim 1, wherein:
the bent structure located at the boundary between the front side portion and the back side portion includes two cut structures on an inner side; and
the two cut structures are disposed at a distance corresponding to a thickness of the deformation suppressing portion.

5. A method for manufacturing a cooling device, the cooling device including an exterior portion including flat cooling surfaces on front and back sides, and a deformation suppressing portion that is housed inside the exterior portion and suppresses deformation of the exterior portion, the method comprising:
a press-forming step of press-forming the exterior portion on a metal plate; and
a bending step of bending the metal plate at a boundary between a front side portion and a back side portion of the exterior portion to house the deformation suppressing portion in the exterior portion.
